(19) United States
(12) Patent Application Publication
(10) Pub. No.: US 2011/0299914 A1
(43) Pub. Date: Dec. 8, 2011

(54) RING BINDER MECHANISM

(76) Inventor: Chun Yuen TO, New Territories (HK)

(21) Appl. No.: 12/868,847

(22) Filed: Aug. 26, 2010

(30) Foreign Application Priority Data
Jun. 2, 2010 (CN) 201010192164.0

(51) Int. Cl. B42F 13/16

(52) U.S. Cl. 402/31

(57) ABSTRACT

A ring binder mechanism (10) to be secured with a cover (30) is disclosed as including an upper housing (12) with two through holes (20) and two side skirts (28) depending from the housing (12), a pair of hinged plates (14) supported by the housing (12), and a number of pairs of half-rings (16) mounted to the plates (14), and the plates (14) are pivotable between an open configuration in which the half-rings (16) are open and a closed configuration in which the half-rings (16) are closed to form a number of closed rings, and each through hole (20) is to be secured with the cover (30) via a rivet (38) only, and that the side skirts (28) abut the cover (30) when the ring binder mechanism (10) is secured with the cover (30).

This invention relates to a ring binder mechanism and, in particular, such a mechanism securable to a substrate to form a paper-retaining device, such as a box file or document holder, and a paper-retaining device incorporating such a ring binder mechanism.

In a conventional paper-retaining device such as box file or document holder, a ring binder mechanism may be fixedly secured to a substrate (e.g. a box file cover or document holder cover) for releasably retaining sheets of hole-punched paper or similar material. As the cover is usually made of such materials as cardboard or plastic and the ring binder mechanism is usually made of a metal or metal alloy, the ring binder mechanism is usually more durable than the cover. However, as the ring binder mechanism is fixedly secured to the cover, it is very difficult, if at all possible, to detach the mechanism from the substrate without damaging the cover and/or the ring binder mechanism.

In addition, when securing a ring binder mechanism to the cover, it is usually necessary to secure each hole of an upper housing of the ring binder mechanism with both an eyelet and a barrel, both made of a metal or a metal alloy, in order to engage the ring binder mechanism to the cover securely and stably. This clearly increases the use of materials and the cost of production.

It is thus an object of the present invention to provide a ring binder mechanism and a paper-retaining device incorporating such a ring binder mechanism in which the aforesaid shortcomings are mitigated, or at least to provide a useful alternative to the trade and public.

According to a first aspect of the present invention, there is provided a ring binder mechanism adapted to be secured with a substrate, said ring binder mechanism including a housing with at least one through hole and two side skirts depending from said housing, a pivotable structure supported by said housing, and a plurality of pairs of half-ring members mounted to said pivotable structure, wherein said pivotable structure is pivotable between an open configuration in which said pairs of half-ring members are open and a closed configuration in which said pairs of half-ring members are closed to form a plurality of closed rings, characterized in that said through hole is adapted to be secured with said substrate via one securing member only, and that said side skirts are adapted to abut said substrate when said ring binder mechanism is secured with said substrate.

According to a second aspect of the present invention, there is provided a paper-retaining device including a ring binder mechanism secured with a substrate, wherein said ring binder mechanism includes a housing with at least one through hole and two side skirts depending from said housing, a pivotable structure supported by said housing, and a plurality of pairs of half-ring members mounted to said pivotable structure, wherein said pivotable structure is pivotable between an open configuration in which said pairs of half-ring members are open and a closed configuration in which said pairs of half-ring members are closed to form a plurality of closed rings, characterized in that said through hole is secured with said substrate via one securing member only, and that said side skirts abut said substrate.

An embodiment of the present invention will now be described, by way of an example only, with reference to the accompany drawings, in which:

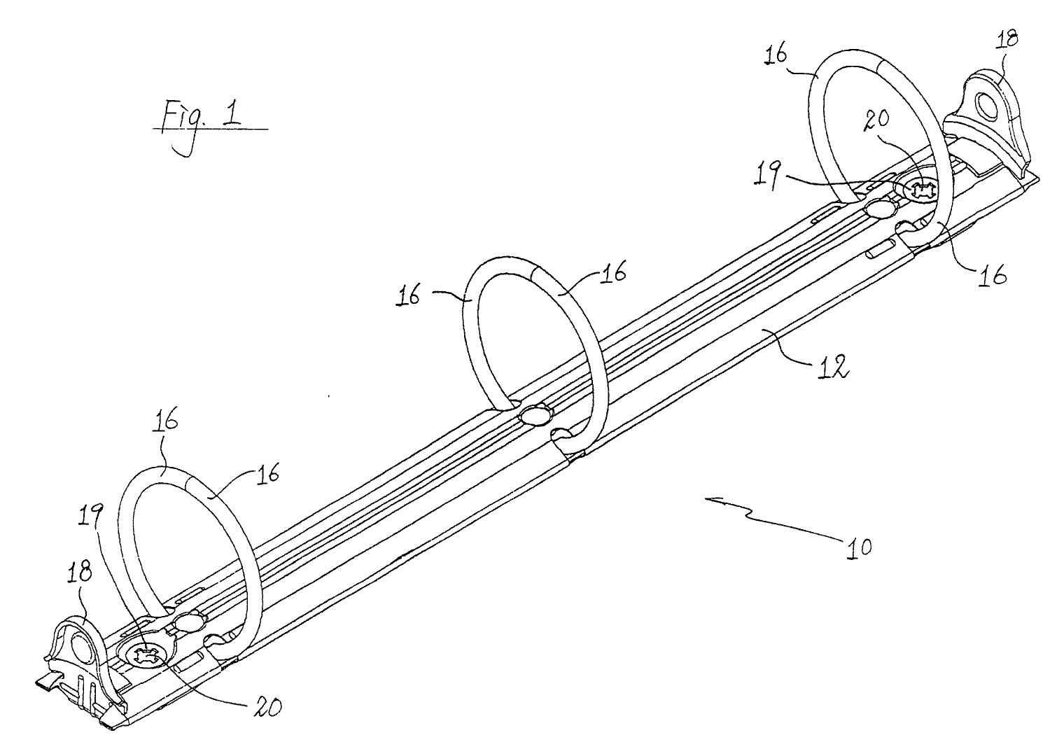

FIG. 1 is a top perspective view of a ring binder mechanism according to an embodiment of the present invention;

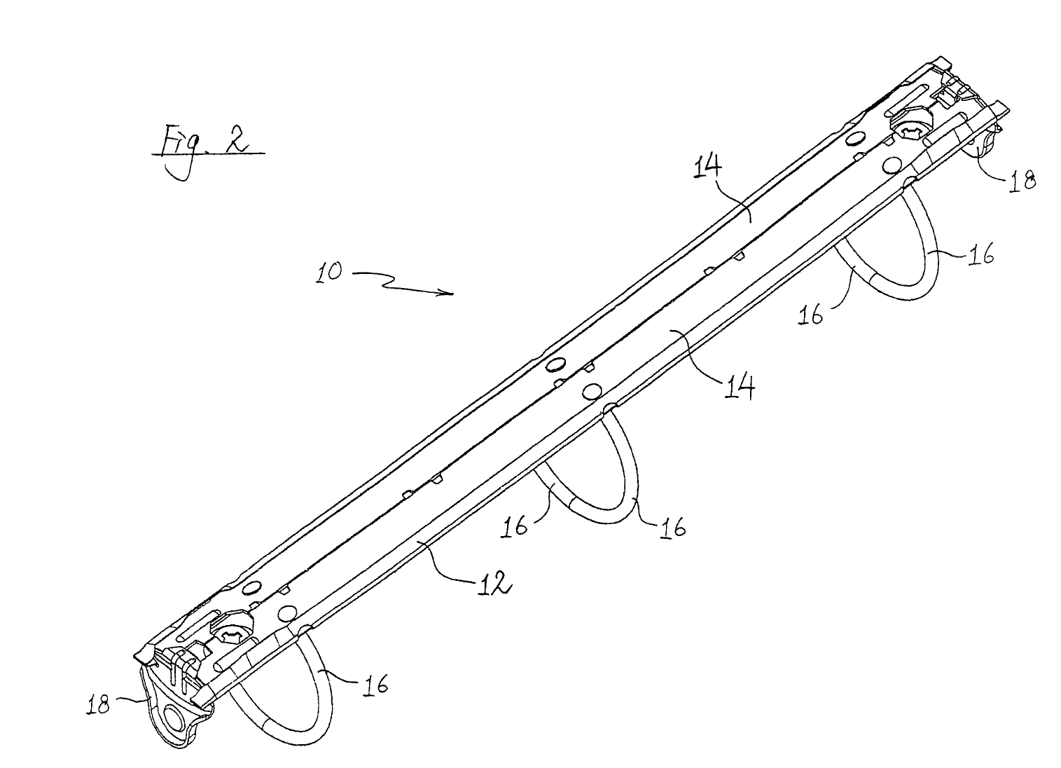

FIG. 2 is a bottom perspective view of the ring binder mechanism of FIG. 1;

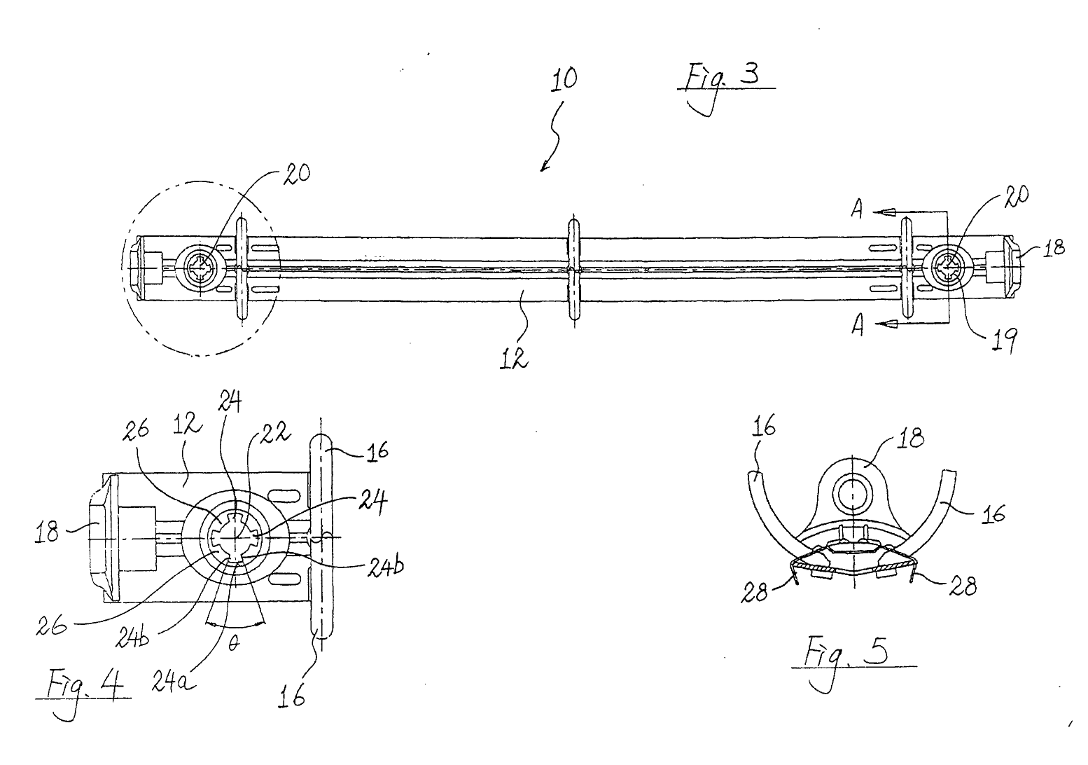

FIG. 3 is a top view of the ring binder mechanism of FIG. 1;

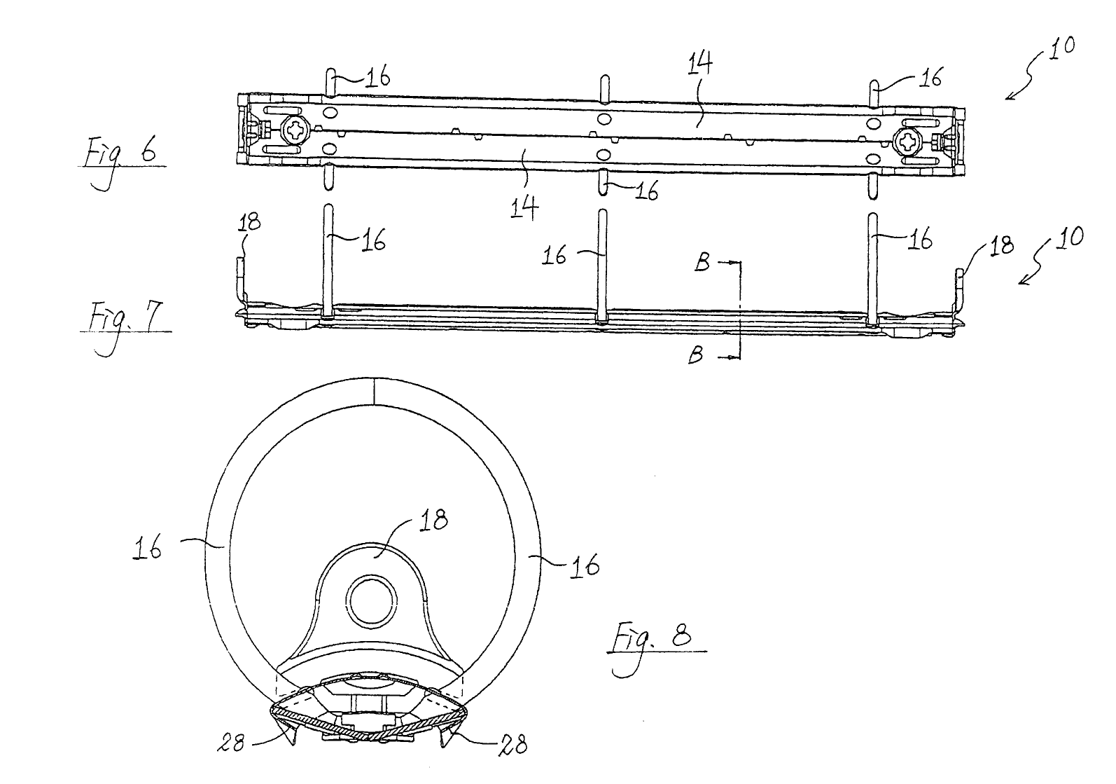

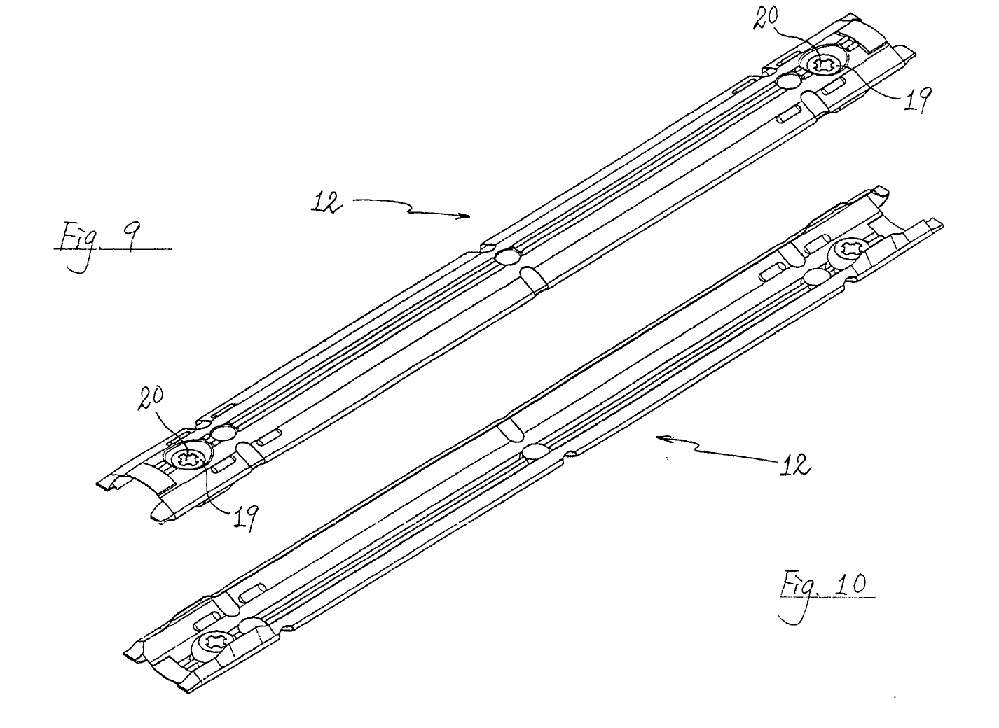

FIG. 4 is an enlarged view of the encircled part in FIG. 3;

FIG. 5 is a partial sectional view taken along the line A-A of FIG. 3;

FIG. 6 is a bottom view of the ring binder mechanism of FIG. 3;

FIG. 7 is a side view of the ring binder mechanism of FIG. 6;

FIG. 8 is a sectional view taken along the line B-B of FIG. 7;

FIG. 9 is a top perspective view of an upper housing of the ring binder mechanism of FIG. 1;

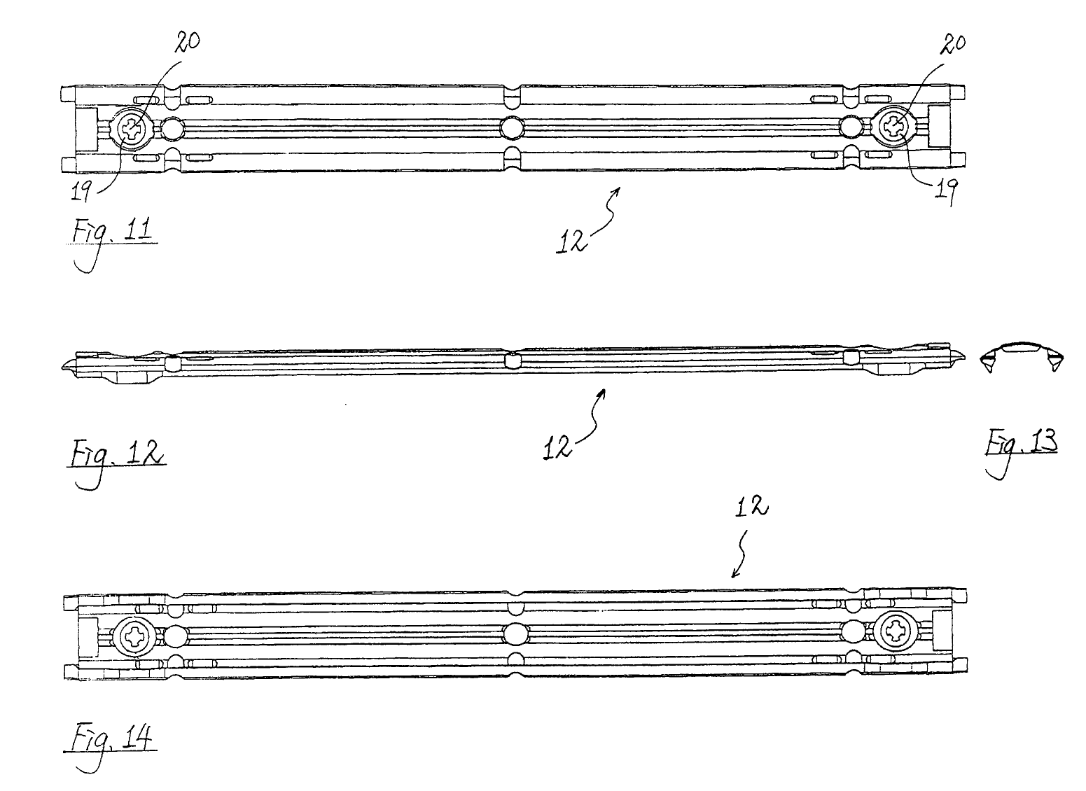

FIG. 10 is a bottom perspective view of the upper housing of FIG. 9;

FIG. 11 is a top view of the upper housing of FIG. 9;

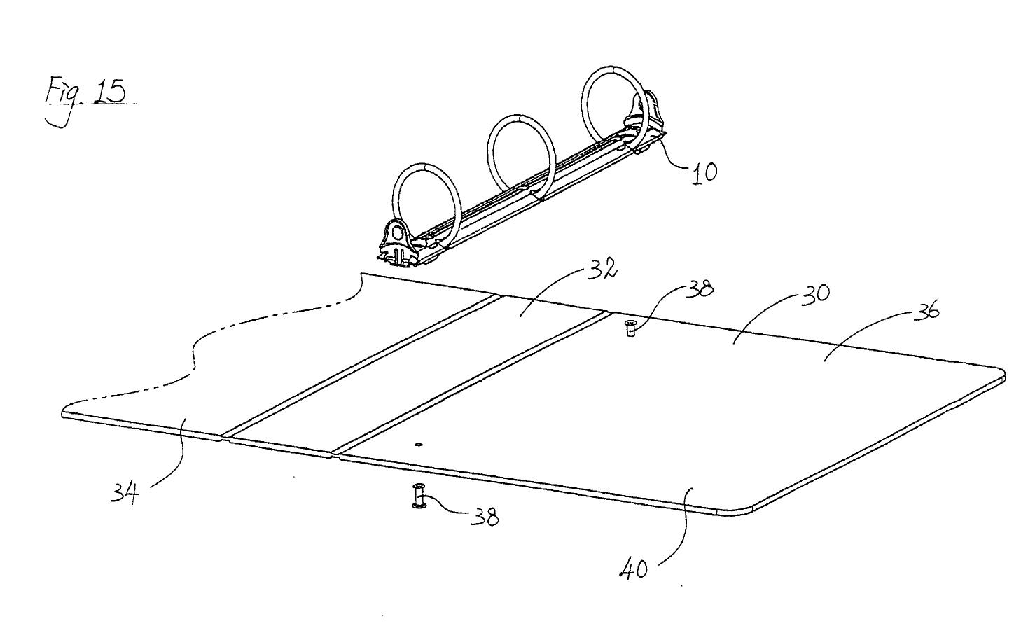

FIG. 12 is a side view of the upper housing of FIG. 11;

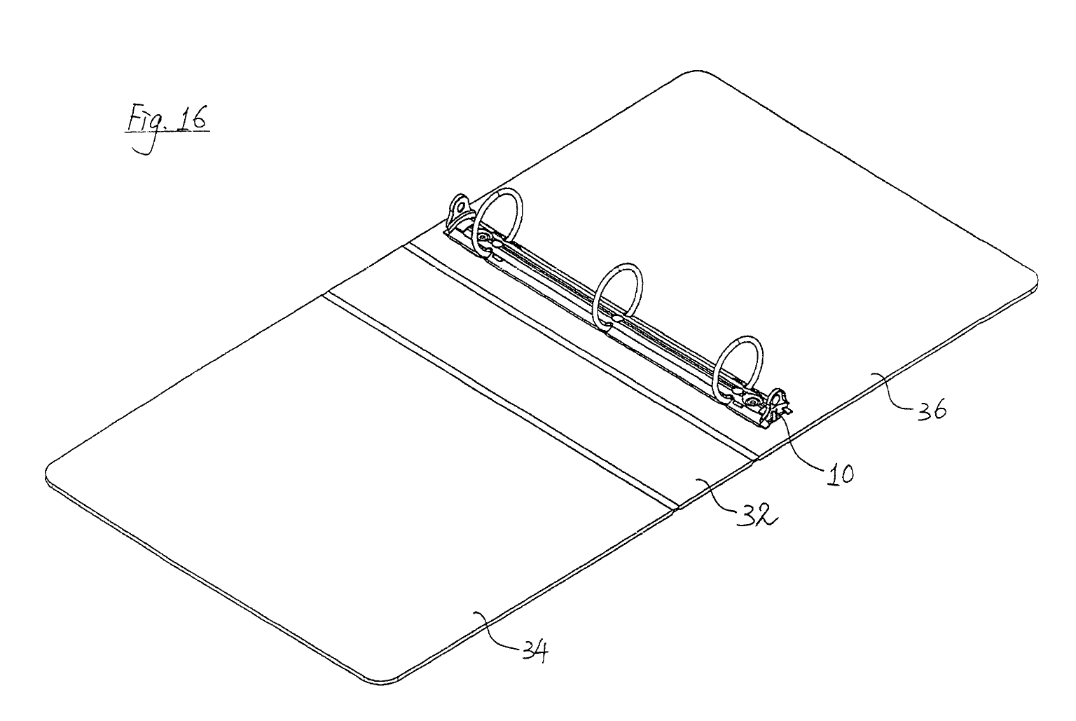

FIG. 13 is an end view of the upper housing of FIG. 12;

FIG. 14 is a bottom view of the upper housing of FIG. 11;

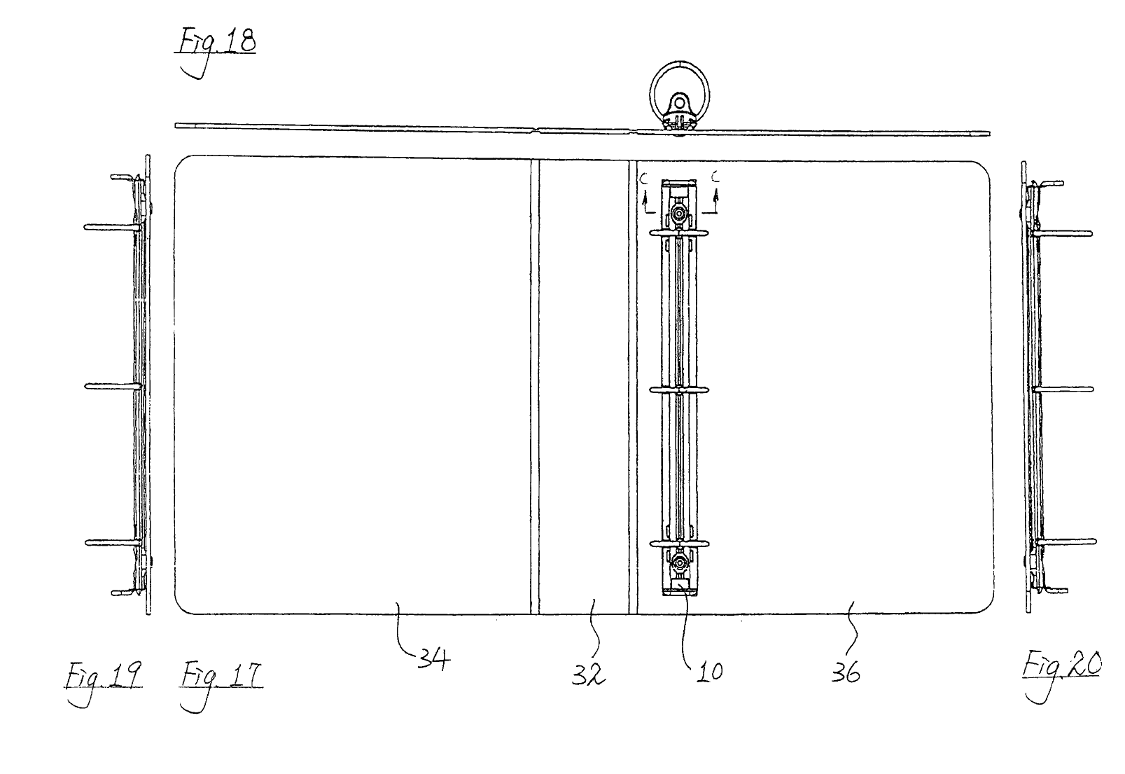

FIG. 15 shows the ring binder mechanism of FIG. 1 to be secured with a cover;

FIG. 16 shows a paper-retaining device, comprising the ring binder mechanism of FIG. 1 secured with a cover;

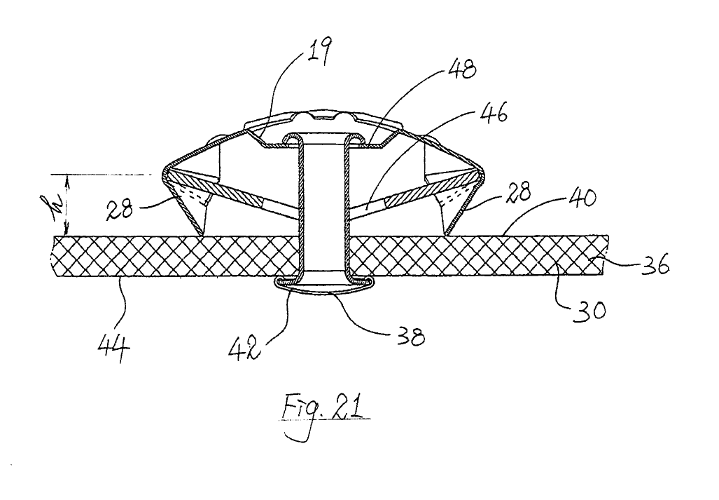

FIG. 17 is a top view of the paper-retaining device of FIG. 16;

FIG. 18 is a front view of the paper-retaining device of FIG. 17;

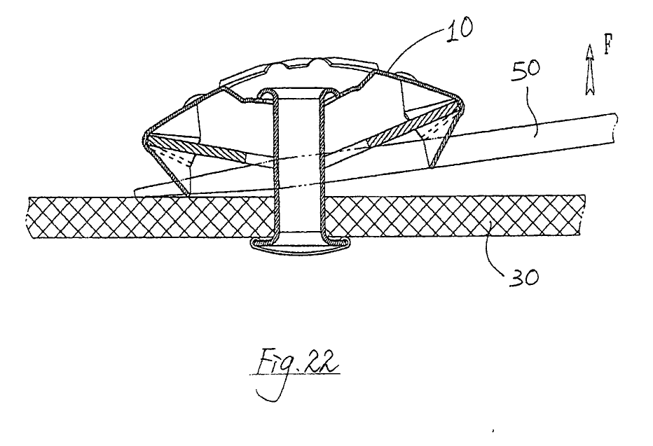

FIG. 19 is a right side view of the paper-retaining device of FIG. 17;

FIG. 20 is a left side view of the paper-retaining device of FIG. 17;

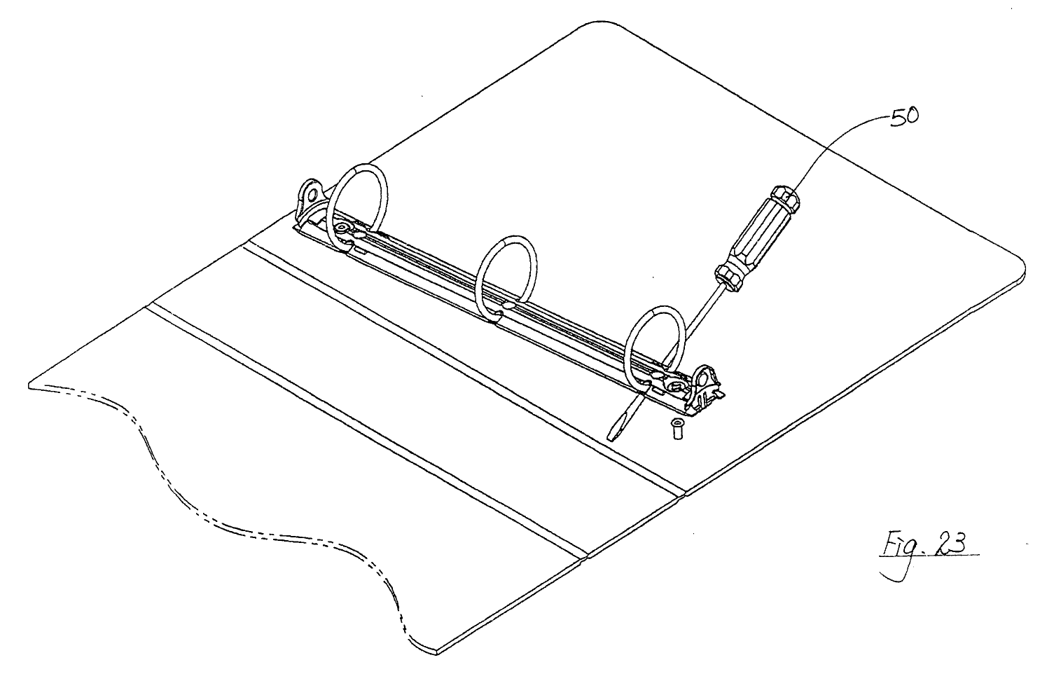

FIG. 21 is an enlarged sectional view taken along the line C-C in FIG. 17 with the operating lever removed;

FIG. 22 shows insertion of a screwdriver between the ring binder mechanism and the cover of the paper-retaining device of FIG. 16; and

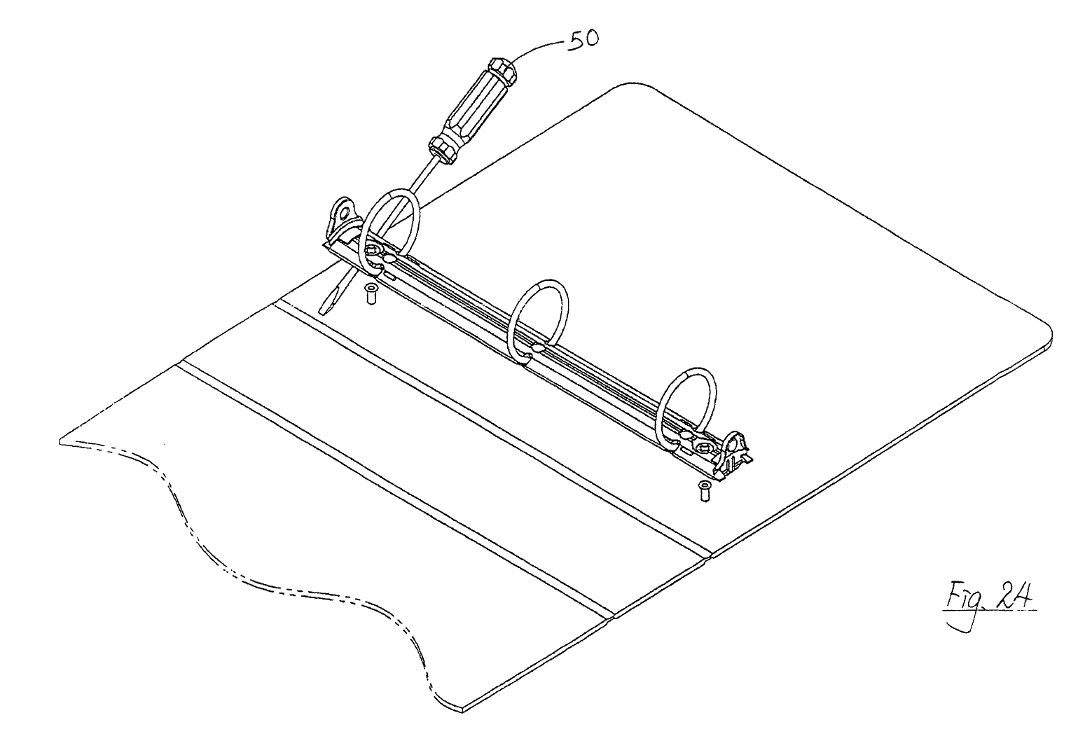

FIGS. 23 and 24 show the steps of detaching the ring binder mechanism from the cover of the paper-retaining device of FIG. 16.

FIGS. 1 to 8 show various views of a ring binder mechanism according to an embodiment of the present invention, generally designated as 10. The ring binder mechanism 10 has an upper housing 12 supporting a pair of plates 14 which are hinged with each other for relative pivoting action.

To each of the plates 14 are mounted three half-rings 16. Each longitudinal end of the ring binder mechanism 10 is engaged with a respective operating lever 18. The operating levers 18 are pivotable relative to the housing 12 and the plates 14 to selectively pivot the pair of plates 14 between a closed configuration and an open configuration. When the pair of plates 14 are in the closed configuration, the surfaces of the pair of plates 14 facing the housing 12 subtend an angle of less than 180° such that free ends of the three pairs of half-rings 16 mate and contact with each other to form three closed rings (as shown in FIGS. 1 to 8). When the pair of plates 14 are in the open configuration, the surfaces of the pair of plates 14 facing the housing 12 subtend an angle of over 180° such that the free ends of the three pairs of half-rings 16 are out of contact with each other to open the rings.

It is of course well known to persons skilled in the art that it is possible to open or close the rings by forcing the free ends of the half-rings 16 apart or together, thus dispensing with the operating levers 18.

As shown in FIGS. 1 and 3, adjacent each longitudinal end of the housing 12 is provided a recessed region 19 with a through hole 20. As can be seen more clearly in FIG. 4, each through hole 20 has a central generally circular aperture 22 and four equi-angularly positioned recesses 24 adjoining the central aperture 22. Each recess 24 has an outer curved edge 24a adjoining two straight side edges 24b. The two side edges 24b subtend an angle of 50°. By way of such an arrangement, four equi-angularly positioned tongues 26 are formed around the central aperture 22 of each through hole 20. These tongues 26 are to be engaged with a rivet (also called “eyelet”) for engaging the ring binder mechanism 10 with a cover, to be discussed below.

It can also be seen from FIGS. 5 and 8 that the housing 12 has two lateral side skirts 28 depending therefrom.

FIGS. 9 to 14 show various views of the housing 12 of the ring binder mechanism 10.

As shown in FIG. 15, a paper-retaining device (e.g. a box file or document holder) may be formed by securing the ring binder mechanism 10 to a substrate, e.g. a cover 30. The cover 30 may be made of cardboard, plastics, metal, metal alloy or a combination of such materials. The cover 30 includes a central spine 32 which is hingedly joined on one side with a front cover 34 and on another side with a rear cover 36. The ring binder mechanism 10 is then secured to an inner major surface 40 of the rear cover 36 by two rivets 38. A paper-retaining device so formed is shown in FIGS. 16 to 20.

It can be seen from FIG. 21 that each through hole 20 is engaged with the cover 30 via a rivet 38 only. The rivet 38 is received through the cover 30 in such a way that a longitudinal head 42 of the rivet 38 is in contact with an outer major surface 44 of the rear cover 36 which is opposite to the inner major surface 40. The rivet 38 is also received through a hole 46 formed between the pair of hinged plates 14, which is aligned with the through hole 20. An upper longitudinal end of the rivet 38 is deformed to be engaged with an upper surface 48 of the housing 12 around the through hole 20. In particular, the deformed upper longitudinal end of the rivet 38 is engaged with the tongues 26 around the through hole 20.

To enhance the stability of the ring binder mechanism 10 relative to the cover 30, it can be seen from FIG. 21 that, when the ring binder mechanism 10 is secured with the cover 30, the side skirts 28 abut the inner surface 40 of the rear cover 36 of the cover 30 along the whole length of the side skirts 28. It should be noted that the effective height h of the side skirts 28 above the cover 30 is such that the pivoting movement of the operating levers 18 is not hindered by the cover 30.

When it is desired to disassemble the paper-retaining device by detaching the ring binder mechanism 10 from the cover 30, and as shown in FIG. 22, a screwdriver 50 may be inserted between the ring binder mechanism 10 and the cover 30 adjacent one longitudinal end of the ring binder mechanism 10. The screwdriver 50 may then be pivoted in the direction indicated by the arrow F, so as to disengage the deformed upper longitudinal end of the rivet 38 from one or two tongues 26 around the hole 20, whereby one longitudinal end of the ring binder mechanism 10 may be detached from the rivet 38, as shown in FIG. 23. More particularly, in doing so, the deformed upper longitudinal end of the rivet 38 is slid through the space between the outer curved edges 24a and adjoining straight side edges 24b of the two diametrically opposed recesses 24 which are positioned generally on the centre line of the housing 12. The other longitudinal end of the ring binder mechanism 10 may be detached from the cover 30 by the use of the screwdriver 50 in a similar manner.

An advantage of the present invention is that, as compared with the prior art ring binder mechanisms, the ring binder mechanism 10 of the present invention can be securely and stably engaged with a cover 30 although no barrel is used. Another advantage is that it is relatively easy to detach the ring binder mechanism 10 from the cover 30, if necessary and desired. Both of these features render the present ring binder mechanism 10 environmentally friendly, easier to manufacture and thus less costly.

It should be understood that the above only illustrates and describes an example whereby the present invention may be carried out, and that modifications and/or alterations may be made thereto without departing from the spirit of the invention. It should also be understood various features of the invention which are, for brevity, described here in the context of a single embodiment, may also be provided separately or in any suitable sub-combination.

1. A ring binder mechanism adapted to be secured with a substrate, said ring binder mechanism including:
a housing with at least one through hole and two side skirts depending from said housing, a pivotable structure supported by said housing, and a plurality of pairs of half-ring members mounted to said pivotable structure,
wherein said pivotable structure is pivotable between an open configuration in which said pairs of half-ring members are open and a closed configuration in which said pairs of half-ring members are closed to form a plurality of closed rings,
wherein said through hole is adapted to be secured with said substrate via one securing member only, and that said side skirts are adapted to abut said substrate when said ring binder mechanism is secured with said substrate.

2. A ring binder mechanism according to claim 1, wherein said housing includes at least two through holes with each of which a respective securing member is securable.

3. A ring binder mechanism according to claim 1, wherein each or said securing member has a first longitudinal end and a second longitudinal end, that said first longitudinal end is securable with an upper surface of said housing around said through hole, and that said second longitudinal end is adapted to be engaged and in contact with a first major surface of said substrate.

4. A ring binder mechanism according to claim 3, wherein when said ring binder mechanism is secured with said substrate, said side skirts are adapted to abut a second major surface of said substrate which is opposite to said first major surface.

5. A ring binder mechanism according to claim 1, wherein each or said through hole has a central aperture and a plurality of recesses adjoining said central aperture.

6. A ring binder mechanism according to claim 5, wherein each said recess has two edges which subtend an angle of substantially 50°

7. A ring binder mechanism according to claim 1, wherein said side skirts are adapted to abut said substrate along at least a majority of the length of said side skirts.

8. A paper-retaining device including a ring binder mechanism according to claim 1, secured with a substrate, wherein said through hole is secured with said substrate via one securing member only, and that said side skirts abut said substrate.
